(19) United States
(12) Patent Application Publication
(10) Pub. No.: US 2015/0058171 A1
(43) Pub. Date: Feb. 26, 2015

(54) ONLINE MARKETPLACE FOR SERVICES

(71) Applicant: Haramol Singh Sandhu, McLean, VA (US)

(72) Inventor: Haramol Singh Sandhu, McLean, VA (US)

(21) Appl. No.: 14/459,114

(22) Filed: Aug. 13, 2014

Related U.S. Application Data
(60) Provisional application No. 61/869,302, filed on Aug. 23, 2013.

(51) Int. Cl. G06Q 30/06; G06Q 30/02

(52) U.S. Cl. CPC G06Q 30/0631; G06Q 30/0627; G06Q 30/0282
USPC 705/26.63

(57) ABSTRACT

A method and system of providing for ratings and recommendations made by knowledgeable third parties as to the competency and fitness of a service provider for the particular project for which the service buyer is currently seeking service providers, together with the aggregation of that data with other data (including other ratings for the particular project, ratings made by service buyers after project completion, and all such data with respect to all projects for the service provider), facilitates the matching of highly qualified service providers with projects/jobs. In addition, because the system harnesses the collective wisdom of all peer raters and expert raters and uses methodologies to encourage the proliferation of accurate and useful ratings data with respect to service providers, the system is able to utilize the power of the Internet to collect and aggregate these opinions and ratings/rankings in a manner not easily replicable through offline methods. Furthermore, a dynamic market for service providers is contemplated whereby useful information as to the competency of service providers is available to all potential service buyers and whereby suitable projects are matched with service providers in search of work. This dynamic market results from the proliferation of the peer and expert ratings data, along with the aggregation/averaging of such data together with ratings provided by service buyers upon project completion (potentially with the use of sub-category or specialty sub-ratings, weighting algorithms, a rating methodology such as the hourly value ratings system, and/or other methodologies that improve the usefulness and accuracy of the aggregate/average ratings data).

### CROSS REFERENCE TO RELATED APPLICATIONS

This application claims priority under 35 U.S.C. §119(e) of U.S. Provisional Application 61/869,302, filed Aug. 23, 2013, the entire contents of which are hereby incorporated by reference.

### FIELD OF THE INVENTION

The present invention relates to the online procurement of services. More specifically, the present invention relates to the connecting of service buyers and service providers for projects/jobs via the Internet.

### BACKGROUND

There are a number of methods whereby potential buyers of services can be connected with service providers via the Internet. For example, search engines are sometimes used to help service buyers find service providers to provide the desired services. In addition, a number of websites specifically provide for listings of service providers/professionals (such as, for example, linkedin.com). Still other websites provide for projects and the matching of service buyers and service providers (such as, for example, guru.com and elance.com), with many of these websites also providing for the rating of service provider performance upon project completion.

However, current websites provide inadequate information to service buyers as to the general competency of a service provider, and even less adequate information as to whether the service provider's skills and competency are a good fit for the particular project for which the service buyer is hiring. As a result, the matching of service providers and service buyers has remained inefficient, even with the proliferation of websites that attempt to match service buyers and service providers. This continuing inefficiency is in contrast to the market for goods, as online marketplaces connecting consumers with goods have increased efficiency in the market for such goods. A large factor in this discrepancy is due to the heterogeneous nature of services and service providers, as compared to goods. Nevertheless, current service provider ratings methodologies often rely primarily on limited project ratings given by past service buyers of the service provider's services (which may be with respect to projects that, while in broadly the same field, required different competencies than the particular project for which services are requested). Furthermore, because ratings are only provided upon project completion through these websites in most cases, if at all, and because the ratings under these websites are primarily only given by a limited number of service buyers, who may not be as familiar with the range of competency of service providers in the field, the resulting aggregate and average ratings data with respect to many service providers is often not very robust nor very informative to future service buyers.

### REFERENCES CITED

U.S. Patent Documents Other than the Related Non-Provisional patent application

| | | |
|---|---|---|
| U.S. 2007/0192130 | August 2007 | Sandhu |
| U.S. Pat. No. 8,380,709 B1 | February 2013 | Diller et. al. |

### SUMMARY

The peer ratings and expert ratings described in this document involve ratings/rankings and recommendations given by third parties who are often in the same field or personally knowledgeable as to the competency of a service provider (or who are willing to otherwise determine the competency of a service provider such as, for instance, through independently contacting individuals with knowledge as to the competency of a service provider). In addition, these ratings are a specific assessment of the service provider's competency with respect to the particular project for which the service buyer is seeking service providers. As a result, the system facilitates the hiring of highly-qualified service providers for a service buyer's project. In addition, because the system harnesses the collective wisdom of all peer raters and expert raters and uses methodologies to encourage the proliferation of such ratings data with respect to service providers, the system is able to utilize the power of the Internet to collect and aggregate these opinions and ratings/rankings in a manner not easily replicable through offline methods.

In addition, because service providers are inherently motivated to select high-performing peers to work on a project alongside them (and further motivated by the ratings methodologies described herein to select high-performing peers) and because experts are motivated by monetary and/or other rewards to select high-performing service providers, the system encourages the providing of high-quality service, and the providing (and proliferation) of useful and accurate service provider ratings, in a manner, and to a degree, not provided by current service provider ratings methodologies.

Furthermore, a dynamic market for service providers is contemplated whereby useful information as to the competency of service providers is available to all potential service buyers and whereby suitable projects are matched with service providers in search of work. This dynamic market results from the proliferation of the third-party ratings data, along with the aggregation/averaging of such data together with ratings provided by service buyers upon project completion (potentially with the use of sub-category or specialty sub-ratings, weighting algorithms, a rating methodology such as the hourly value ratings system, and/or other statistical or other methodologies that improve the usefulness and accuracy of the aggregate/average ratings data).

### BRIEF DESCRIPTION OF THE DRAWINGS

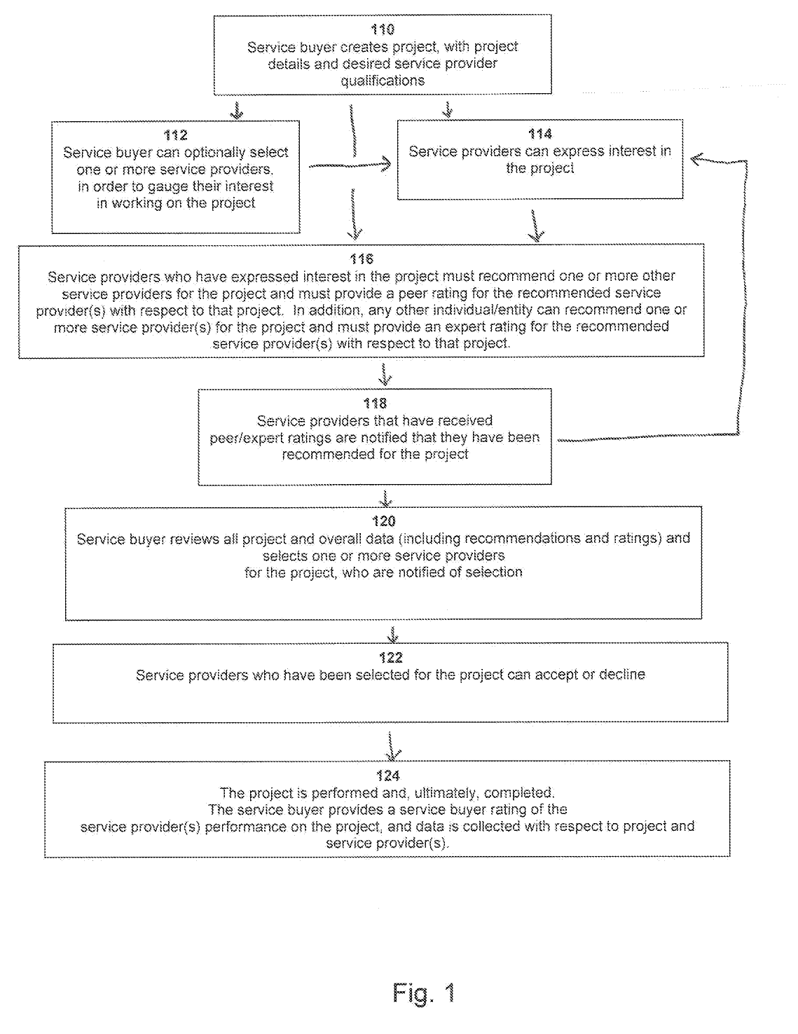

Non-limiting and non-exhaustive embodiments of the invention are described, in part, with reference to FIG. 1, which is an exemplary flow chart showing the steps taken with respect to a project/job.

### DETAILED DESCRIPTION

This document describes a system and method for facilitating the procurement of qualified service providers for a particular project. In addition, this document describes a dynamic market for professional services that results from the aggregation of the data described herein with respect to multiple projects. In the following description, numerous specific details are set forth to provide a thorough understanding of the embodiments. One skilled in the relevant art will recognize, however, that the techniques described herein can be practiced without one or more of the specific details, or with other methods or details. In other instances, well-known operations are not shown or described in detail to avoid obscuring certain aspects. For example, details relating to networks, such as the Internet generally and more specifically common methods and processes used in websites connecting service buyers and service providers, details included in websites with profiles of professionals/service providers, search engine processes, and processes related to accessing a database of service provider profiles are not described in detail herein.

Reference throughout this specification to “one embodiment” or similar terminology means that a particular feature, structure, or characteristic described in connection with the embodiment is included in at least one embodiment of the present invention. Thus, the appearances of the phrase “in one embodiment” or similar terminology in various places throughout this specification are not necessarily all referring to the same embodiment. Furthermore, particular features or characteristics described herein may be combined in any suitable manner in one or more embodiments.

In one embodiment, a service buyer creates a project/job on the marketplace website describing the scope of the project and the desired skills and expertise that service providers should possess in order to be considered for the project 110. This project page can contain a variety of information about the project, including total number of service providers that the service buyer who is the project creator expects to hire, pay, and any other information about the project customarily disclosed when procuring services. Upon project creation (or anytime thereafter), the project creator can optionally select one or more service providers that the service buyer may be interested in hiring for the project 112. The website will contact those service providers 112, whereby the service providers can express interest in the project 114. In addition, other service providers not specifically selected by the project creator can also express interest in the project 114).

In the preferred embodiment, a service provider who expresses interest in a project must select one or more other service providers (peers) that the interested service provider recommends for the same project (and, if applicable, the recommendation would include the specific position within the project for which the peer is recommended—e.g., in the case where different service providers for the project may be performing different jobs within the project and/or where the service buyer desires service providers with different skill sets and/or different skill levels) 116. At this time, the interested service provider (peer rater) must provide a rating (peer rating) for each service provider that the peer rater recommends for the project 116. The peer rating can encompass various rating/ranking methodologies, which provide a measure as to the peer rater's assessment of the fitness of the peer for the project at issue 116. The individual peer ratings provided for the particular project and identity of peer raters are only accessible to the service buyer that is the project creator.

Service providers who have been given a peer rating for a particular project are notified that an individual has recommended them for the project (although, as set forth above, the peer ratings are not disclosed, nor is the identity of the peer rater) 118. Upon notification, the service provider who was recommended can express interest in the project 114. A service provider that expresses interest, in turn, selects one or more peers who the interested service provider recommends for the same project and provides peer ratings for those peers, in the same manner set forth above 116. The peers selected by the service provider who was recommended could be the same service provider that recommended that service provider and/or any other service provider(s) (since the system does not disclose the identity of peer raters, these service providers may not know that they have recommended one another unless, of course, they personally disclose such information to each other).

In the preferred embodiment, ratings (expert ratings) can also be provided prior to project commencement by other third-party individuals or entities (expert raters) that, in contrast to peer raters, have not expressed interest in performing services on that particular project 116. In fact, an expert rater could be a service buyer that has previously hired the service provider for a project or any other individual knowledgeable as to the service provider's work. The function of these expert raters is to recommend to the service buyer other individuals who would be a good fit for a project and provide ratings and/or rankings for those service providers as to the expert rater's assessment of the service provider's fitness for the project at issue. Upon such recommendation and rating/ranking, the service provider who has been recommended will be notified 118. These expert raters could be compensated for providing their expert ratings services for a project either by the service buyer or by the website (or other methodologies could be used to reward and encourage the providing of accurate and useful expert ratings). In addition, it is contemplated that expert raters would receive ratings for their expert rating services, such that those expert raters that recommend high-quality service providers for a project would be rated upon completion of the project for having done so (either for example, in absolute terms, or in terms of the match between the rating provided by the expert rater for a recommended service provider prior to commencement of the project and the rating provided by the service buyer upon completion of the project). Thus, those expert raters that have a good track record of finding highly qualified service providers would be given high average expert ratings scores and could also be flagged by the system through various means (e.g., by showing up high in search results for expert raters), so that these expert raters are likely to be asked by service buyers to provide expert ratings for their project to help them find service providers that would be a good fit.

In the preferred embodiment, it is contemplated that the system would allow interested service providers to contact expert raters through the system, in order to receive an expert rating (and/or other service providers, in order to receive a peer rating but, in such a case that other service provider would have to express interest in order to provide the peer rating). Alternatively (or additionally), the system may suggest to expert raters a listing of service provider and/or open projects for which expert ratings would be beneficial and for which the expert rater would provide valuable ratings (as determined, for example, by the expert rater's past ratings on similar projects and/or past ratings with respect to these or similar service providers). Nevertheless, it is contemplated that the system would not explicitly disclose who provided a peer rating and/or expert rating and what that rating was to the service provider that is being rated.

Upon the expiration of the project staffing period (or such other time as set forth by the system or selected by the project creator), the service buyer that is the project creator has access to a private portion of a web page (or series of web pages) on the website whereby the project creator can review information with respect to service providers that have expressed interest in the project and/or received a peer or expert rating for the project. Among other information, these private project web pages accessible to the project creator might include the following with respect to these service providers: all expressions of interest, peer ratings for that project, expert ratings for that project, averages of such ratings (which can be weighted and determined algorithmically) applicable to each service provider for the current project, and overall and other average ratings applicable to each service provider (which could also incorporate ratings data from past projects), and other service provider profile information. Service providers could be ranked on these web pages according to one or more of these ratings. At this time, the service buyer that is the project creator selects one or more service providers for the project 120. Although the project creator has access to peer recommendations provided by service providers (in the form of the peer ratings provided by peer raters), as well as expert ratings, the service buyer need not select service providers together, but can select them independently regardless of each service provider's recommendations.

Service providers who have been selected for the project are notified of their selection 120. All service providers who have been selected for the project can view the identity of all other service providers selected for the project (but cannot view the specific peer or expert ratings data provided by other individuals, nor can they view the identity of the peer and expert raters). Each selected service provider is able to accept or decline the project 122.

Thereafter, the project is performed, and ultimately completed 124. In some embodiments, payments from the project creator to service providers for the work performed could be made through the system (either on a periodic basis or after project completion). In some embodiments, in addition to the peer ratings provided before the project commences, service providers who are working on a project can provide ongoing peer ratings of other service providers on that project, adjust peer ratings while the project is being performed, and/or provide peer ratings upon project completion.

Upon project completion, in the preferred embodiment, the service buyer that is the project creator provides ratings (service buyer ratings) of the service providers based on their actual performance on that project 124.

In some embodiments, the system may utilize additional methods of encouraging the recommendation of high-quality peers for projects. For example, the system may require that the service buyer provide a single rating for the project upon project completion that is applicable to all service providers who worked on the project. This would further incentivize service providers to select high-quality peers, since the work of the peer will directly influence the rating given to the service provider. Alternatively, the system could require that the service buyer provide an overall project rating upon project completion that is applicable to all service providers but also provide individual ratings to each service provider, with both the overall and individual ratings weighted and averaged to determine the service provider's publicly available average ratings. These ratings provided by the project creators as well as peer ratings would be aggregated algorithmically to determine the average rating for the service provider, that is publicly available on the service provider's profile page (or alternatively, available to service buyers who are logged in). The average ratings for a service provider could be further subcategorized in project categories, so that ratings on a project within a particular category are used to determine average ratings for that subcategory of projects for the service provider.

Both the peer and expert ratings are provided to service buyers by third parties and offer an assessment by that third party as to the competency and fitness of a service provider for the particular project for which the service buyer is currently seeking service providers. Alternatively, the system could combine peer and expert raters into one category of third-party raters, such that any third party can provide such a rating, and be incentivized to provide accurate ratings and quality recommendations through the methodologies described above (including, for example, through monetary rewards).

In addition to information customarily available on websites and/or provided in resumes/CVs with respect to a service provider's skills and expertise, the preferred embodiment will include service provider profile pages that average/aggregate ratings data generated from the system (including peer, expert, and service buyer ratings). This data could also be subcategorized based on particular job classifications and average ratings could be determined algorithmically, whereby certain ratings are given more or less weight due to various factors in determining the average rating for the service provider. For example, the weight a rating is given in determining the applicable average for the service provider (including project sub-category averages and/or sub-category averages with respect to peer, expert, and service buyer ratings, and/or other sub-categories) could depend on the overall pay of project, the length of the project, the time elapsed since project completion, and/or other factors with respect to the project and/or rater. It is further contemplated that a service provider could have multiple profiles and/or sub-profiles such as, for example, if such service provider performs projects more than one category/sub-category and projects within that category/sub-category will be used to determine average/aggregate sub-category data.

In addition, in determining the average peer ratings, average expert ratings, and/or the average overall rating for a service provider (or category sub-rating, or any other average, aggregate, or other rating determined by the system), ratings by experts or peers that have demonstrated past ability to provide accurate ratings (as calculated by the variance between peer/expert ratings before the project and service buyer ratings upon project completion with respect to past projects, or some other measure of accuracy) and/or past ability to provide high-quality recommendations (as calculated by some measure of high ratings, such as high ratings for service providers that match the high ratings given by service buyers to the same service providers upon project completion) may be given more weight. Conversely, experts or peers that have limited history of ratings data and/or a history of inaccurate or low-quality ratings may be given less weight in calculating such averages. With respect to expert ratings, for example, the weightings could also be influenced by whether or not the expert rater had past work experience with the service provider (for example, having previously hired the service provider or worked with the service provider). With respect to peer ratings, for example, the weighting could also be influenced by whether or not the peer rater had previously worked on another project with the service provider being rated (and potentially also whether on these past projects the service provider being rated received a high rating after the project by the service buyer that was the project creator of that project). Similarly, in determining average service buyer ratings and/or average overall ratings applicable to a service provider, ratings by service buyers that statistically have great variance from ratings provided by other service buyers on other projects and/or from ratings provided by peers or expert raters (with respect to the same and/or other projects) with respect to that service provider may be given less weight.

The ratings methodology used can take on various forms, including percentile scores, numerical scores on a scale, alphabetical grades, stars, yes/no or recommend/decline, or any other form. In the preferred embodiment, an hourly value ratings system is used, whereby the peer rater, expert rater, and/or service buyer assigns to the service provider a rating equal to the maximum hourly fee that the peer rater, expert rater, and/or service buyer believes the service provider's work on the project will be (in the case of peer and expert raters) or was worth (in the case of the service buyer upon completion of the project), regardless of the amount actually paid by the service buyer for the service. Other similar ratings systems that more usefully measure performance may be used, so that the average and aggregate data that results is more meaningful and it is easier to compare differences in competency and service level provided by service providers. Multiple types of ratings systems could also be used so that, for example, both an hourly value ratings system and a numerical grade are assigned. In addition, there may be multiple ratings provided by the rater with respect to a service provider for a project, such as, for example, if the service provider can perform multiple tasks on the project, there may be sub-ratings for each task. In addition, it is contemplated that in addition to a rating, other information may be provided by the rater that could be used by the system and, for example, potentially included on a service provider's profile page, such as a written text/narrative recommendation.

It is contemplated that some or all of service provider profile information, such as some or all of the average ratings data applicable to a service provider, will be broadly accessible to individuals who access the website, while other information will only be accessible to a project creator (such as project-specific information and ratings) and other information will only be accessible to the service provider. Similarly, it is contemplated that some or all the project information will be broadly accessible to individuals who access the website, while other information will only be accessible to the project creator and/or service providers working on a project. For example, it is contemplated that, while individual peer, expert, and service buyer ratings would not be accessible to all individuals that access a service provider's profile page on the website, some or all of the average/aggregate ratings data would be accessible and could also be used to influence service provider search results rankings or ordering of service providers in a list within a category/sub-category.

These and other embodiments can optionally include other features to ensure higher-quality peer, expert, service buyer, and/or overall aggregate ratings. For example, the system could provide that peer ratings can be combined and used with expert ratings, so that even if a service provider is not selected for a project or decides that he or she is not interested in performing services on a project, that service provider's peer ratings could be used as expert ratings. Alternatively, or additionally, peer raters could be compensated by the system or the service buyer (in a manner similar to expert raters) for providing high-quality recommendations of other service providers. In addition, peer ratings for a project may be given reduced or no weight in determining average ratings for service providers if the service provider that is the peer rater and/or the service provider who was being rated were not selected for the project for which the peer rating was provided. As another example, only a portion of the high ratings may be used in determining the average for a service provider, while other ratings are not used. As another example, a service provider may have the ability to delete peer ratings and all related project data for the related project that the service provider does not want the system to incorporate in determining the service provider's average rating (although there could be systems to discourage the deletion of data, such as higher service provider search result rankings in the system for service providers who have more ratings data). As another example, a service provider who has provided inaccurate peer ratings may be penalized by the system so that the service provider's own average service provider ratings are affected.

These and other embodiments can optionally include a feature whereby, if a particular service provider has already been recommended by another peer, the system would record a subsequent peer recommendation and rating made by another service provider but also require that the subsequent service provider select another peer for recommendation and rating/ranking (or other methodologies to encourage ratings/rankings of more service providers). In addition, the system could either limit the number of other service providers that a service provider who expresses interest could rate/rank/recommend (i.e., to only one service provider) and/or provide that the service provider rate/rank a minimum number of service providers (and these limits could be different depending potentially on the project and the number of total service providers the service buyer is seeking for the project).

It is also contemplated that service providers who have high average ratings in categories/sub-categories matching a desired service provider search will show up higher in service provider search results on the system (and other factors can also influence service provider search result ordering, such as, for example, the number of projects performed by the service provider for which there is data, how close the service provider's expertise matches the search, etc.).

It is also contemplated that, in addition to individuals recommending service providers for a project via expert and peer recommendations and ratings, in the preferred embodiment the system will automatically suggest service providers for the project to the project creator and/or otherwise flag service providers that appear to be a good match for a project at the time of project creation (taking into account all relevant data, particularly as the system gets more robust with more detailed service provider profiles, including increasing peer, expert, and service buyer ratings) and more extensive past project data (including similarities in scope and expertise required in the current project as compared to other past projects and/or comparison of highly-rated service providers for similar past projects), so that the project creator can potentially contact some or all of these service provider's to determine if one or more would be interested in the project. 112. Similarly, in the preferred embodiment, it is contemplated that the system will automatically suggest projects to service providers, taking into account service provider data and project data (including past project history of the service provider, such as similarities in scope and expertise of the open projects compared to projects completed by the service provider and/or projects for which the service provider received high peer, expert, service buyer, and/or aggregate ratings).

The present invention has been described in terms of specific embodiments incorporating details to facilitate the understanding of principles of construction and operation of the invention. The description herein is not intended to be exhaustive or to limit the invention to the precise forms disclosed. Thus, for example, even though service buyers, service providers, expert raters, and peer raters are generally described as individuals herein, it is contemplated that each can instead be groups of individuals or entities. Similarly, even though the invention is generally described as applying to discrete projects herein, it is contemplated that this invention can also apply to longer-term jobs.

It will be readily apparent to one skilled in the art that other various modifications may be made to the embodiments chosen for illustration without departing from the spirit and scope of the invention.

The invention claimed is:

1. A computer implemented method for the use of an online services marketplace, comprising: accepting a posting on a website of a project that a service buyer wants completed; providing a database containing all registered service providers; permitting third parties to provide ratings and recommendations prior to the start of a project as to the expected performance of a particular service provider on that project, given the project specifications and the service provider's expertise.

2. The computer implemented method of claim 1; further comprising a service buyer that has hired service provider(s) for a particular project on the marketplace to provide ratings and recommendations as to the hired service provider(s) actual performance on that project upon project completion.

3. The computer implemented method of claim 1, wherein the ratings provided are an opinion of the expected dollar value provided per hour worked or billed (regardless of actual fee charged).

4. The computer implemented method of claim 2, wherein the ratings provided are an opinion of the expected dollar value provided per hour worked or billed (regardless of actual fee charged), in the case of third party ratings, and an opinion of the actual dollar value provided per hour worked or billed (regardless of actual fee charged), in the case of service buyer post-project ratings.

5. The computer implemented method of claim 1, wherein the recommendations and ratings provided by third parties are divided between peer ratings, given by other service providers who have expressed interest in working on that particular project, and expert ratings, given by third parties who have not expressed interest in working on that particular project.

6. The computer implemented method of claim 2, further comprising weighted average ratings for a service provider with respect to a project and aggregated across several projects, with adjustments in weighting given to ratings provided by third parties to reflect the accuracy of past ratings given to service providers by that rater as compared to post-project ratings given on the past project by the service buyer of that past project (determined by measuring the variance between the third-party rating and the service buyer's post-project rating).

7. The computer implemented method of claim 4, further comprising weighted average ratings for a service provider both with respect to a project and aggregated across several projects, with adjustments in weighting given to ratings provided by third parties to reflect the accuracy of past ratings given to service providers by that rater as compared to post-project ratings given on the past project by the service buyer of that past project (determined by measuring the variance between the third-party rating and the service buyer's post-project rating).

8. The computer implemented method of claim 6, wherein the weighted average ratings are also adjusted to reflect the number of prior ratings given by a rater and the length of the project or total amount of compensation received on the project for which the rating was provided.

9. The computer implemented method of claim 7, wherein the weighted average ratings are also adjusted to reflect the number of prior ratings given by a rater and the length of the project or total amount of compensation received on the project for which the rating was provided.

10. The computer implemented method of claim 6, wherein separate weighted average ratings for a service provider are determined with respect to a project, with respect to projects within a particular sub-category (sub-categorized according to the project specifications or expertise required), and with respect to all projects.

11. The computer implemented method of claim 7, wherein separate weighted average ratings for a service provider are determined with respect to a project, with respect to projects within a particular sub-category (sub-categorized according to the project specifications or expertise required), and with respect to all projects.

12. The computer implemented method of claim 8, wherein separate weighted average ratings for a service provider are determined with respect to a project, with respect to projects within a particular sub-category (sub-categorized according to the scope of project and expertise required), and with respect to all projects.

13. The computer implemented method of claim 9, wherein separate weighted average ratings for a service provider are determined with respect to a project, with respect to projects within a particular sub-category (sub-categorized according to the scope of project and expertise required), and with respect to all projects.

14. The computer implemented method of claim 2, further comprising incentives given to third parties that provide accurate recommendations and ratings of service providers (determined by measuring the variance between the pre-project rating given by the third party and the post-project rating given by the service buyer on a particular project).

15. The computer implemented method of claim 4, further comprising incentives given to third parties that provide accurate recommendations and ratings of service providers (determined by measuring the variance between the pre-project rating given by the third party and the post-project rating given by the service buyer on a particular project).
